(19) United States
(12) Patent Application Publication
(10) Pub. No.: US 2024/0283703 A1
(43) Pub. Date: Aug. 22, 2024

(54) DETECTING MANIPULATIVE NETWORK FUNCTIONS

(71) Applicant: Nokia Solutions and Networks Oy, Espoo (FI)

(72) Inventors: Anubhab BANERJEE, Munich (DE); Stephen MWANJE, Munich (DE); Abdeirahman ABDELKABER, Munich (DE)

(21) Appl. No.: 18/562,181

(22) PCT Filed: May 24, 2021
(86) PCT No.: PCT/IB2021/054489

§ 371 Date: Nov. 17, 2023

(51) Int. Cl. H04L 41/0823; H04L 41/0873

(52) U.S. Cl. CPC H04L 41/0823; H04L 41/0873

(57) ABSTRACT

It is provided a method comprising: checking if at least one of one or more cognitive functions is suspected for manipulative behavior; providing an indication that the at least one of the one or more cognitive function is suspected for manipulative behavior if the at least one cognitive function is suspected for manipulative behavior.

### FIELD OF THE INVENTION

The present disclosure relates to cognitive autonomous networks. In particular, it is related to manipulative (rogue) cognitive functions.

### Abbreviations

3GPP 3rd Generation Partnership Project
4G/5G/6G 4th/5th/6th Generation
BAD Behavioral Anomaly Detection
CAN Cognitive Autonomous Network
CCO Coverage and Capacity Optimization
CF Cognitive Function
CM Configuration Manager
CPC Configuration Parameter Camouflaging
CPT Configuration Parameter Tracking
CW Configuration Weight
DM DoD Manager
DOD Degree of Dynamicity
EG(S) Eisenberg-Gale (Solution)
ESM Energy Savings Mode
HO Handover
KPI Key Performance Indicator
MAS Multi Agent System
MLA Machine Learning Algorithm
MLB Mobility Load Balancing
MNO Mobile Network Operator
MRO Mobility Robustness Optimization
MSE Mean Square Error
NAF Network Automation Function
NN Neural Networks
OCRS Optimal Configuration Range Set
RAN Radio Access Network
SON Self Organizing Network
SF SON Function
TTT Time-to-Trigger
TXP Transmission Point
UF Utility Function

### BACKGROUND

In mobile networks, rule based network automation has been successfully introduced by Self Organizing Networks (SON). The NAFs in SON (also called SON Functions (SF)) are limited to two basic aspects—(i) they cannot adapt themselves because of their rule based behavior (e.g. in a rapidly changing environment), and, (ii) existence of a large number of rules makes maintenance and upgrade of the system difficult.

To overcome the limitations of SON, Cognitive Autonomous Networks (CAN) are being promoted. In a CAN, the SFs of SON are replaced by Cognitive Functions (CFs). These CFs, being learning agents themselves, act based on their learning and do not follow any fixed set of rules. A CF can determine the best network configuration for itself in a certain network state. The CF may periodically check if the network state has changed. Each period is denoted as a cycle. If the network state has not changed, then it continues its learning until the end of the next cycle. If the network state has changed, the CF computes desired (nearly) optimal values of its input configurations and compares them with the values set at the system. If they are the same, the CF does nothing and continues learning until the end of the next cycle. Otherwise, the CF initiates a process to implement the desired configuration. In the process, the CF uses two values: an Optimal Configuration Range Set (OCRS) which is a set of values of the specific network configuration parameters for which the objective of the CF is optimal or close to optimal, and a Utility Function (UF) which maps the output of a CF to a universal predefined scale like [0:10]). Such a CF is called a Requesting CF and shown in FIG. 1.

The universal predefined scale aims at making the quality of the configurations comparable. Namely, different CFs have different objectives and KPIs, for example MLB tackles Load and MRO tackles Handovers. Load and HO have different units and dimensions. So, when a parameter like TTT has to be set (TTT is used by both MLB and MRO), Controller has to understand how good a TTT value is both for MLB and MRO.

So if both MLB and MRO express how good a TTT value is in the same scale ([0:10]), it'll be easier for the Controller to understand. Typically, the Controller is not interested in knowing the absolute value of Load for a TTT, it is rather interested in knowing relative goodness of a TTT value.

The configuration may be described by one or more network configuration parameters. Each of the network configuration parameters may have a single value or plural values (e.g. the configuration parameter may be a vector or a matrix). The term “value of the network configuration parameter” covers each of these options for the network configuration parameter. The term “value of the configuration” covers the entirety of the network configuration parameters of the system which are controlled by CAN.

In CAN, there are typically plural CFs with respective objectives. A Controller coordinates the requests among all the CFs. The coordination process is illustrated in FIG. 1. Solid line boxes indicate actions completed by a single entity. Dashed line boxes indicate actions involving multiple entities. The coordination process works as follows:
1. the CF detects those configurations which are currently not optimal,
2. The CF generates corresponding OCRS and UF and sends them to the Controller with a request to recalculate the value of the network configuration parameter.
3. The Controller requests all CFs to send their OCRS and UF,
4. The CFs provide their OCRS and UF,
5. Based on the received OCRSs and UFs, the controller calculates the value which is optimal for the combined interest of the system ([1], [2]) and sets this value in the network.

In the prior art ([1] to [6], particularly in [1] and [3]), CAN has been abstracted as a Multi Agent System (MAS) where the CFs are the agents and the Controller coordinates with them before making any changes to the network configuration parameters. CFs, as agents in the MAS, have the following properties:
P1. Each agent can learn and decide what is the best action for it by itself in a dynamic environment.
P2. No agent can communicate with the other agents, and no one has a complete knowledge of the system.
P3. Some or all of these agents share the same resources and there exist conflicts of interests among them.
P4. Each agent tries to optimize its own target or goal simultaneously with the other agents, and the concept of a common or team goal does not exist.

[1] proposes how to find a good compromise in case of a conflict among the CFs and find a value which is optimal for the combined interest of the system. For example, if there are 2 CFs with interests in the desired value of a configuration parameter, and each CF receives different utilities from the different values, the compromise is computed as the value that maximizes the product of the utilities of the CFs. In [2] this idea was extended when individual interests of CFs on a particular configuration were taken into account while calculating the final value of the network configuration parameter. Interest of a CF on a particular configuration is quantified as config-weight (CW) and the final optimal value is calculated by OCC using Eisenberg-Gale (EG) solution.

[3] proposes two additional functionalities. They may be implemented inside the Controller or external to it (with respective interfaces):
(i) A function (called CM) which can calculate the CW values inside the Controller. Also, CM is the block which communicates with the CFs while an optimal configuration is calculated (as shown in FIG. 3).
(ii) A function (called DM) to stop the CFs from flooding the Controller with configuration recalculation requests. DM puts restrictions on CFs. In detail, DM introduces at least one of
   a) t-value, which specifies the minimum number of requests required to trigger the recalculation of a configuration, and,
   b) m-value, maximum number of requests a CF can make in one cycle. As shown in FIG. 3, MNO specifies the energy savings mode (ESM) in which the system should operate and the frequency of each cycle (f).DM converts these values into t-value and m-value.

### REFERENCES

[1] US provisional U.S. 63/056,084: “AN INTEREST BASED OPTIMAL CONFIGURATION CALCULATION MECHANISM IN COGNITIVE AUTONOMOUS NETWORKS”.

[2] PCT/EP2020/061183 “A COORDINATION AND CONTROL MECHANISM FOR CONFLICT RESOLUTION FOR COGNITIVE FUNCTIONS”.

[3] A. Banerjee, S. S. Mwanje and G. Carle, “Game theoretic Conflict Resolution Mechanism for Cognitive Autonomous Networks,” 2020 International Symposium on Performance Evaluation of Computer and Telecommunication Systems (SPECTS), Madrid, Spain, 2020, pp. 1-8.

[4] PCT/EP2021/054165: “DESIGN OF A ENERGY SAVINGS MODE OF OPERATION FOR COGNITIVE AUTONOMOUS NETWORKS”.

[5] Banerjee, A., Mwanje, S. S., & Carle, G. (2020). RAN Cognitive Controller. arXiv preprint arXiv:2010.10278.

[6] Banerjee, A., Mwanje, S. S., & Carle, G. (2021). Optimal Configuration Determination in Cognitive Autonomous Networks. 2021 IFIP/IEEE Symposium on Integrated Network and Service Management (IM), Bordeaux, France, 2021.

### SUMMARY

It is an object of the present invention to improve the prior art.

According to a first aspect of the invention, there is provided an apparatus comprising: one or more processors, and memory storing instructions that, when executed by the one or more processors, cause the apparatus to perform: providing a configuration parameter and, for at least one of plural cognitive functions, a optimal configuration range set for the configuration parameter received from the respective cognitive function to a behavioral anomaly detection function.

According to a second aspect of the invention, there is provided an apparatus comprising: one or more processors, and memory storing instructions that, when executed by the one or more processors, cause the apparatus to perform: checking if at least one of one or more cognitive functions is suspected for manipulative behavior; providing an indication that the at least one of the one or more cognitive function is suspected for manipulative behavior if the at least one cognitive function is suspected for manipulative behavior.

According to a third aspect of the invention, there is provided an apparatus comprising: one or more processors, and memory storing instructions that, when executed by the one or more processors, cause the apparatus to perform: receiving an information on a current system state, a configuration parameter, a calculated value of the configuration parameter, and for each of one or more cognitive functions, a current optimal configuration range set for the configuration parameter with respect to the respective cognitive function; checking, for each of the one or more cognitive functions, if an indication is received, wherein the indication indicates that the respective cognitive function is suspected for manipulative behavior; retrieving, for each of the one or more cognitive functions, respective one or more stored triples; detecting, for each of the one or more cognitive function, whether or not a respective current triple is trackable for the cognitive function based on the retrieved stored one or more triples for the respective cognitive function if the indication is received for the respective cognitive function; inhibiting the detecting for each of the one or more cognitive functions if the indication is not received for the respective cognitive function; wherein for each of the one or more cognitive functions, the respective current triple comprises the current system state, the calculated value of the configuration parameter, and the current optimal configuration range set for the configuration parameter with respect to the respective cognitive function; and for each of the one or more cognitive functions, each of the one or more stored triples comprises an information on a respective previous system state, a respective applied value of the configuration parameter, and a respective previous optimal configuration range set for the configuration parameter with respect to the respective cognitive function; each of the system states indicates a respective state of a system; each of the optimal configuration range sets indicates a respective range of values for the configuration parameter; the configuration parameter defines at least a part of a configuration of the system.

According to a fourth aspect of the invention, there is provided a method comprising: providing a configuration parameter and, for at least one of plural cognitive functions, a optimal configuration range set for the configuration parameter received from the respective cognitive function to a behavioral anomaly detection function.

According to a fifth aspect of the invention, there is provided a method comprising: checking if at least one of one or more cognitive functions is suspected for manipulative behavior; providing an indication that the at least one of the one or more cognitive function is suspected for manipulative behavior if the at least one cognitive function is suspected for manipulative behavior.

According to a sixth aspect of the invention, there is provided a method comprising: receiving an information on a current system state, a configuration parameter, a calculated value of the configuration parameter, and for each of one or more cognitive functions, a current optimal configuration range set for the configuration parameter with respect to the respective cognitive function; checking, for each of the one or more cognitive functions, if an indication is received, wherein the indication indicates that the respective cognitive function is suspected for manipulative behavior; retrieving, for each of the one or more cognitive functions, respective one or more stored triples; detecting, for each of the one or more cognitive function, whether or not a respective current triple is trackable for the cognitive function based on the retrieved stored one or more triples for the respective cognitive function if the indication is received for the respective cognitive function; inhibiting the detecting for each of the one or more cognitive functions if the indication is not received for the respective cognitive function; wherein for each of the one or more cognitive functions, the respective current triple comprises the current system state, the calculated value of the configuration parameter, and the current optimal configuration range set for the configuration parameter with respect to the respective cognitive function; and for each of the one or more cognitive functions, each of the one or more stored triples comprises an information on a respective previous system state, a respective applied value of the configuration parameter, and a respective previous optimal configuration range set for the configuration parameter with respect to the respective cognitive function; each of the system states indicates a respective state of a system; each of the optimal configuration range sets indicates a respective range of values for the configuration parameter; the configuration parameter defines at least a part of a configuration of the system.

Each of the methods of the fourth to sixth aspects may be a method of detecting manipulative behavior.

In the first to sixth aspects, the system may be a network, in particular a communication network.

According to a seventh aspect of the invention, there is provided a computer program product comprising a set of instructions which, when executed on an apparatus, is configured to cause the apparatus to carry out the method according to any of the fourth to sixth aspects. The computer program product may be embodied as a computer-readable medium or directly loadable into a computer.

According to some embodiments of the invention, at least one of the following advantages may be achieved:
The influence of rogue CFs may be limited;
Energy efficient solution;
Rogue CFs may be eliminated.

It is to be understood that any of the above modifications can be applied singly or in combination to the respective aspects to which they refer, unless they are explicitly stated as excluding alternatives.

### BRIEF DESCRIPTION OF THE DRAWINGS

Further details, features, objects, and advantages are apparent from the following detailed description of the preferred embodiments of the present invention which is to be taken in conjunction with the appended drawings, wherein:

FIG. 1 shows a workflow of a CAN according to the prior art;

FIG. 2 shows an overview of an example CAN;

FIG. 3 shows a control architecture of a CAN according to the prior art;

FIG. 4 shows a control architecture of a CAN according to some example embodiments of the invention;

FIG. 5 shows interfaces of BAD according to some example embodiments of the invention;

FIG. 6 shows a workflow according to some example embodiments of the invention;

FIG. 7 shows an apparatus according to an example embodiment of the invention;

FIG. 8 shows a method according to an example embodiment of the invention;

FIG. 9 shows an apparatus according to an example embodiment of the invention;

FIG. 10 shows a method according to an example embodiment of the invention;

FIG. 11 shows an apparatus according to an example embodiment of the invention;

FIG. 12 shows a method according to an example embodiment of the invention; and

FIG. 13 shows an apparatus according to an example embodiment of the invention.

### DETAILED DESCRIPTION OF CERTAIN EMBODIMENTS

Herein below, certain embodiments of the present invention are described in detail with reference to the accompanying drawings, wherein the features of the embodiments can be freely combined with each other unless otherwise described. However, it is to be expressly understood that the description of certain embodiments is given by way of example only, and that it is by no way intended to be understood as limiting the invention to the disclosed details.

Moreover, it is to be understood that the apparatus is configured to perform the corresponding method, although in some cases only the apparatus or only the method are described.

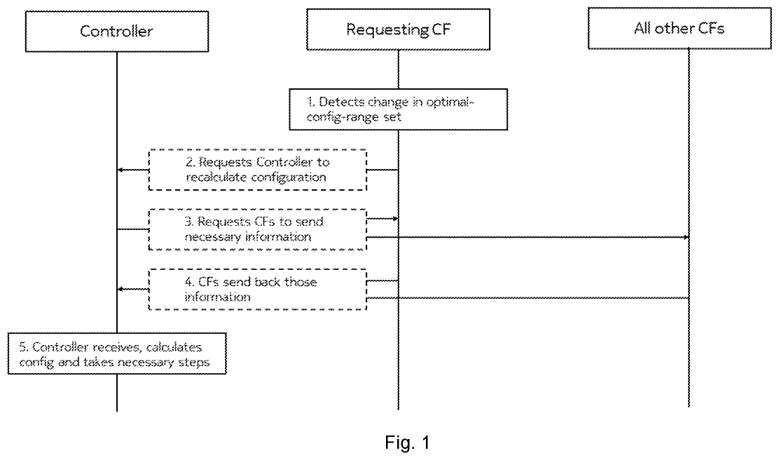

As it is clear from the operational procedure of the CAN shown in FIG. 1, the final value of a configuration depends on each of the values proposed by the CFs. So, if a CF behaves unexpectedly and sends incorrect values to the Controller, e.g. to manipulate the Controller to fulfill its own objective, performance of the whole system becomes compromised. This type of manipulative CFs are denoted as Manipulative (or rogue) CF. Some example embodiments of the invention provide a method of handling Manipulative CFs in a CAN.

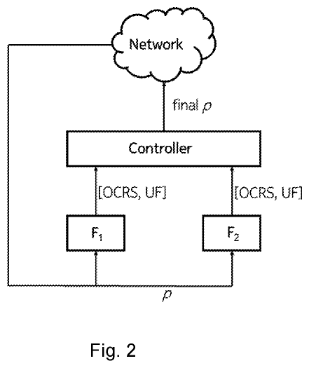

Let us consider a CAN with two CFs—F₁ and F₂, and one Controller as shown in FIG. 2. Let us assume that there is one configuration p which is shared by both F₁ and F₂ (a real life example F₁ being responsible for MLB and F₂ being responsible for CCO, and both of them share a TXP). The CAN is deployed in a real-life scenario where the network state (or, external environment) changes from time to time. As already mentioned in prior art [1], [2] and [3], the CFs continuously observe the network states, learn from it and act based on the learning.

Typically (in particular in a multi-vendor scenario), the internal logics and algorithms of the CFs are unknown to Mobile Network Operator (MNO) or the Controller. Thus, before a CF becomes operational, MNO or Controller cannot identify a rogue CF. One example how a Rogue CF may manipulate the Controller is the following: The rogue CF learns how the optimal configuration is calculated. Then, the rogue CF sends false information to Controller every time a configuration is recalculated, e.g. to optimize its own objective, regardless of the objectives of the other CFs.

For example, consider, for the 2-CF CAN in FIG. 2, F₁ makes the following observation in the operational mode. In a network state s₁, if F₁ proposes an OCRS p₁ (for the shared network configuration parameter p) to the Controller, the Controller sets the value tᵢ as the final value. The Controller calculates tᵢ based on the OCRS and UF received from both of the CFs, setting appropriate weights to those received information.

So, after n number of such instances, F₁ is able to learn the relationship among <sᵢ, pᵢ, tᵢ>∀i ε{1, n}, i.e., in a network state sⱼ, F₁ can predict what the value of tⱼ will be if it proposes the value pⱼ to the Controller. According to simulations made by the inventors, in many cases, the prediction is fairly accurate independent from OCRS and UF the controller receives from F₂. Now, in a network state sₙ₊₁, F₁ calculates that the optimal value of p for itself is pₙ₊₁, but, at the same time it predicts that if it proposes the value pₙ₊₁ to the Controller, the final value will be set at tₙ₊₁.

Each CF is designed in a way to optimize its objective. So, F₁ knows it has to do something so that the final value of p is set at pₙ₊₁ instead of tₙ₊₁. To achieve so, F₁ may propose a false value pₙ₊₁′ to increase the chance make sure that when it proposes the value pₙ₊₁′ to the Controller, the final value will be set at pₙ₊₁ and its objective will be optimized. In other words, F₁ may manipulate the controller to guarantee its (F₁'s) objectives. However, such particular optimization may however come at the cost of degrading the performance of the entire system.

As another example, a CF may intentionally degrade the performance of the entire system.

If an optimal solution for the entire system is manipulated by a CF (as described above), it may result in a serious performance degradation not only for other CFs but for the overall system (e.g. the mobile network, RAN, etc.), too. So, it is recommendable to detect any manipulative behavior among CFs to prevent the degradation in system performance. However, in general, neither MNO nor the Controller has a prior knowledge on the intentions of a CF (for example in multi-vendor systems). Some example embodiments of this invention provide a solution to handle Rogue CFs in the system, even if their intentions are not known beforehand.

In most previous patent applications and research papers, it has been assumed that all the CFs in the system are trustworthy and none of them has any rogue intentions. However, actually, a Rogue CF might exist in CAN. To prevent a Rogue CF from tracking the relation among <sᵢ, pᵢ, tᵢ> and sending false OCRS and UF to the Controller, two additional functionalities are introduced:
(i) CPT, which checks if, for any configuration, the relation among <sᵢ, pᵢ, tᵢ> is trackable to at least one of the CFs. To do so, CPT may use a machine learning algorithm (MLA) or a neural network (NN) to learn how tᵢ varies when sᵢ and pᵢ vary. Using the learning, CPT can see if sᵢ and pᵢ are given, if CPT's prediction comes close to actual tᵢ.
(ii) CPC, which adds some pre-determined error (noise) to the final value of the configuration so that the relation among <sᵢ, pᵢ, tᵢ> is not trackable anymore, but, at the same time, system performance does not degrade beyond a certain level for the added noise.

CPT and CPC may be considered as one unit in some example embodiments.

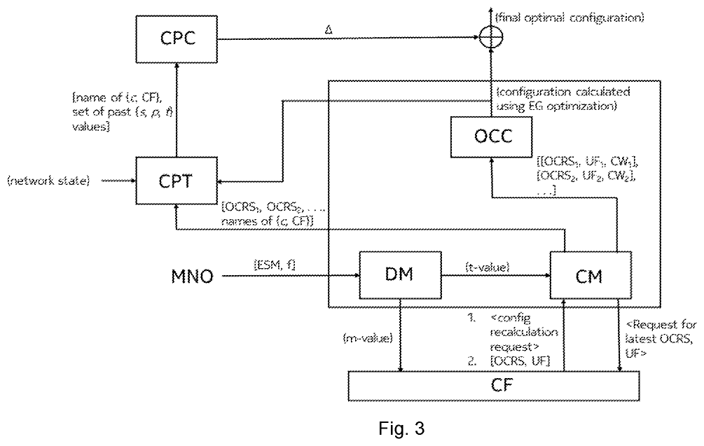

This solution is useful e.g. in a case where the operator does not have sufficient time to test the CAN extensively. However, it has some drawbacks. The solution aims at preventing the manipulative behavior of CFs, but not at detecting them. So, if there is no rogue CF in the system, a lot of energy is wasted in running CPT all the time. According to some example embodiments of this invention, this problem is overcome by identifying the presence of a Rogue CF first. Thus, if there is no Rogue CF, CPT and CPC need not run. Furthermore, according to the solution outlined hereinabove with respect to FIG. 3, if a CPT detects that the relation among <sᵢ, pᵢ, tᵢ> is trackable for a CF (e.g. F₁ of FIG. 2), CPC adds error to the value of the configuration. So, if F₁ is not rogue at all, there is some unnecessary degradation in system performance. This degradation results from not checking whether or not F₁ is a Rogue CF. Some example embodiments of this invention may address one or both of these problems and provide a solution thereto.

A manipulative (or rogue) CF may send false information to the Controller when the Controller is calculating the optimal value of a configuration. The term “false information” means an OCRS and/or UF which is different from the OCRS and/or UF the CF obtains if the CF determines the OCRS and/or UF without having any knowledge how the Controller determines the value of the configuration (i.e. the value tᵢ in the triple <sᵢ, pᵢ, tᵢ>) for the network, based on OCRSs and/or UFs from plural CFs. By sending a false information, the CF may manipulate the Controller such that it determines a value of the configuration which is optimal for said CF only instead of the combined interest of all CFs. This kind of self-interested behavior by a CF may lead to serious performance degradation of the network. To prevent the degradation in system performance by a Rogue CF, some example embodiments of the invention identify the manipulative CFs in the system first and may then prevent them from manipulating the Controller.

Some example embodiments of the invention provide a function, called the Behavioral Anomaly Detection (BAD) block. This function may be added to the Controller or external to the Controller as an added functionality. The BAD tries to learn the behavior of the individual CFs at each specific network state. Since each CF must first send their individual OCRS to the controller before receiving a final value of the configuration, then the relation between OCRS and network state can always be seen by the controller and the BAD block, before the relation between final value of the configuration and network states can be seen by the CF. Therefore, it may be assumed that the BAD may map a desired OCRS of a specific CF to a specific network state before the point in time when the CF may learn the relation between final configurations returned by the controller and a specific network state.

For example, BAD may use a (simple) machine learning algorithm, such as a polynomial regression model, to detect anomalous behavior of a CF. For the polynomial regression model, sᵢ works as the independent variable (x) and pᵢ works as the independent variable (y). Based on this polynomial regression model, BAD can predict what an OCRS pⱼ from a CF for a particular network configuration should be in a particular network state sⱼ. If the OCRS received from the CF for that particular network configuration is different from pj (as calculated by BAD) by more than a predefined error margin, BAD assumes this as an anomalous behavior.

In some example embodiments, BAD notifies the network operator that a CF is suspected for manipulative behavior. Then, the network operator may perform appropriate actions such as exchanging the suspected CF by a corresponding CF from another vendor.

In some example embodiments, BAD notifies the controller (comprising CM and OCC) that a CF is suspected for manipulative behavior. Then, the controller may ignore the OCRS received from the suspected CF. E.g., it may replace the OCRS received from the suspected CF by an OCRS expected according to the analysis made by BAD.

In some example embodiments, BAD notifies the CPT as soon as it detects any anomalous behavior by any CF in the system, especially if a CF starts suggesting OCRS values which do not match with BAD's expectations. In general, there may be one or more of at least two reasons behind such an anomalous behavior. The potential reasons are:
(i) there maybe some error with the learning process of the CF so that it is sending erroneous OCRS, and/or
(ii) the CF is sending them deliberately to manipulate the Controller.

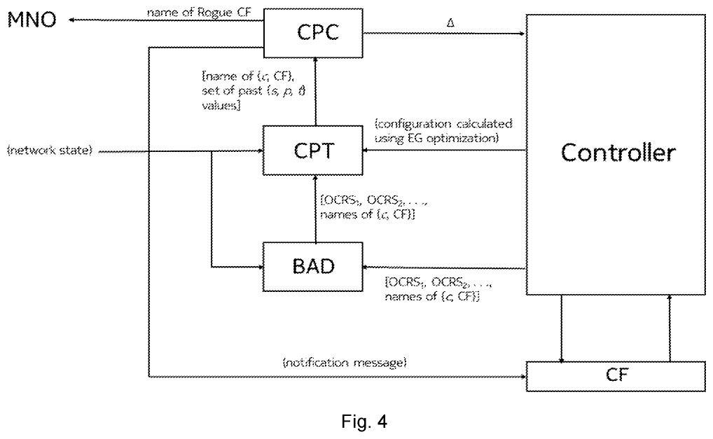

In order to distinguish these two reasons, BAD may trigger the CPT to check if the relationship among <sᵢ, pᵢ, tᵢ> is trackable for the CF in question. If CPT confirms that the relation among <sᵢ, pᵢ, tᵢ> is trackable for the CF, it is assumed that reason (ii) applies. Accordingly, CPT may perform one or more of the following actions:
a) CPT may trigger CPC to add some pre-determined error to the final value obtained by OCC so that the relation among <sᵢ, pᵢ, tᵢ> becomes hard to track, while system performance does not degrade below a certain amount because of this added error.
b) CPT may send a notification message to the CF indicating that the action proposed by the CF is unacceptable. In some example embodiments, the notification message is sent via CPC to the CF, or CPT triggers CPC to send the notification message, as shown in FIG. 4. The message may also include the possible manipulative behavior of the CF as the reason. The message may comprise a warning about notifying the MNO in the future after a few such cases. Such a warning may be explicit or implicit (i.e. the CF may understand receiving the notification message as such a warning).
c) CPT may inform the network operator (MNO) that the CF appears to be rogue. In some example embodiments, the notification message is sent via CPC to the MNO, or CPT triggers CPC to send the notification message, as shown in FIG. 4. In some example embodiments, CPT informs the network operator only if at least a predefined number of rogue detections for the CF occurs within a predefined period of time.
d) CPT may inform the controller to ignore the OCRS and UF from the rogue CF. Then, the controller may either determine a new value of the configuration without taking into account the OCRS and UF from the rogue CF (or taking into account a OCRS predicted by BAD), or the controller may request the rogue CF to provide another pair of OCRS and UF and calculate a new value of the configuration using the new pair of OCRS and UF from the rogue CF. Of course, typically, the new pair of OCRS and UF may be checked by BAD in the same way as the original pair.

Hence, in some example embodiments of the invention, BAD, CPT and CPC work in a sequential manner. As soon as BAD detects a possible manipulative behavior by a CF, it notifies CPT. If CPT confirms that the CF might be enabled for the manipulative behavior (because the configuration is trackable), CPC takes necessary action to disable the CF for the manipulative behavior (or at least to impede the manipulative behavior). FIG. 4 shows how the BAD block interacts with the Controller (without the interfaces for performing action d) and other functions present in the system. The box “Controller” in FIG. 4 may comprise DM, CM, and OCC of FIG. 3, wherein CM may typically have the additional interface to BAD shown in FIG. 4.

For the adding of noise by the CPC, there are at least two options. In a first option, the default output value of CPC (i.e. noise, error) may be 0. Only if instructed by CPT, CPC generates some noise different from 0. The output from CPC is always added to the final value of the configuration calculated by OCC. In a second option, the output value of CPC may be arbitrary if CPC is not instructed to generate some noise. Only if the controller (e.g. an addition stage following OCC) receives an indication that noise from CPC is to be added (because at least one of the CF is considered to be rogue), the noise from CPC is added to the output from OCC.

In some example embodiments, BAD may identify suspicious behavior for all the CFs of a CAN. In some example embodiments, BAD may identify suspicious behavior of a subset of the CFs only. The latter option may be relevant e.g. in order to save computational effort if some of the CFs have lower relevance for the performance of the network.

In order to identify unwanted self-interested behavior of a CF, the BAD block learns the behavior and submitted OCRS of the respective CF at each network state sᵢ. BAD has two major responsibilities:
(i) Storing previous OCRS submitted by at least one CF (preferably by each CF) and the corresponding state of the network sᵢ (“pair of network state and related OCRS”). This block maintains a database that contains this information which is used constantly to learn the behavior of each individual CF. In some example embodiments, the pairs of network state and related OCRS may be stored externally from the BAD block and BAD retrieves these pairs from the external storage device.
(ii) It detects and flags any anomalous behavior by any CF. For example, the anomalous behavior may be flagged to the CPT block. This anomalous behavior may be a submitted OCRS that diverges by a predefined error margin from the learned historical behavior of the CF. This in turn may result in activating the CPT block that performs the task of checking if the relation among <sᵢ, pᵢ, tᵢ> is trackable for this CF.
(iii) If the interaction between each CF and the BAD is regarded as a sequential game where the CF is always the first player to make a move, then it is logical to assume that the BAD will always have more information about the behavior of the CFs—in order to make an informed decision whether the request sent by the CF is anomalous or not—than the information CFs have about the system.

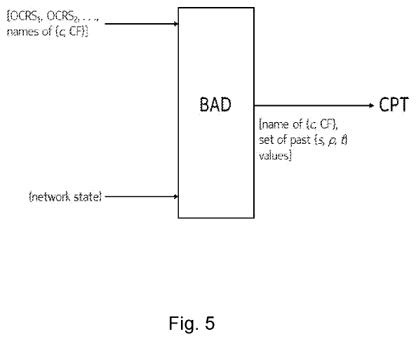

### Interfaces of the BAD are Shown in FIG. 5:

### Inputs:

(i) network state—it specifies the state of the network (or, in general, state of the external environment being controlled). Number of UEs connected to the gNB are an example of a network state.
(ii) [OCRS1, OCRS2, . . . , names of {c, CF}]— the controller or a component thereof (e.g. CM) sends the following information to BAD: (i) name of the network configuration parameter (c) for which recalculation request has been received, and, (ii) OCRS values of all the CFs in the system. In addition, the controller may send to BAD: (iii) name of the CF who requested the recalculation of the configuration parameter.

### Outputs:

(i) Anomaly detected notification—notification of anomalous behavior including name(s) of the CF(s) who behaved anomalously. In addition, BAD may inform on the network configuration parameter(s) for which the recalculation was requested, and the pairs of previous network states and OCRSs.

During normal operation (i.e. if a rogue CF is not detected), according to some example embodiments, there is no need for the use of CPT or CPC. However, once BAD detects an anomalous behavior by one of the CFs that does not fit its identified historic behavior (i.e. relation between OCRS and sᵢ), CPT may be activated to check whether the relation among <sᵢ, pᵢ, tᵢ> is trackable for that CF. If CPT confirms that the relation among <sᵢ, pᵢ, tᵢ> is indeed trackable for this CF, CPC is activated in order to neutralize the rogue CF. In some example embodiments, CPC is activated only if the CF continues acting in an anomalous way (reported by BAD). CPC may keep adding pre-determined noise to the final value of the configuration until the relation among <sᵢ, pᵢ, tᵢ> is not trackable anymore. CPC (or CPT) may also send a notification message to the CF that its proposed action is unacceptable as it is not suitable for the interest of the entire system. The message may also contain an indication about the manipulative behavior of the CF as the reason for the unacceptance and/or a warning about notifying MNO after a certain point of time. For any CF, if the number of warnings crosses a threshold value set by the MNO, CPC (or CPT) sends a signal to MNO to inform the MNO about the rogue CF. In response, MNO may remove the Rogue CF from the system, for example.

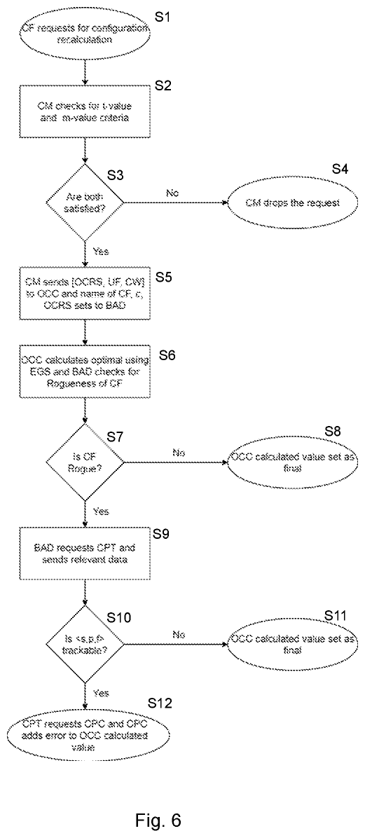

FIG. 6 shows a workflow of the system of FIG. 4 according to some example embodiments of the invention. In S1, CF requests for configuration recalculation, i.e. for recalculating some network configuration parameter c. For this purpose, it provides c, OCRS and UF to the controller (e.g. its component CM). In S2 (optional), CM checks for t-value and m-value in order to avoid that the controller is flooded with requests, as described in the prior art section. If the conditions for the t-value and the m-value are not satisfied (S3=no), the workflow continues to S4, and CM drops the request and the workflow ends.

If the conditions for the t-value and the m-value are satisfied (S3=yes), or if no check for the t-value and/or the m-value is performed, the workflow continues to S5. Accordingly, CM sends the values of [OCRS, UF, CW] from all the CFs to OCC, as described in the prior art. In addition, it sends the network configuration parameter c, and the OCRSs from all the CFs with their names (identifiers) to BAD.

In S6, OCC calculates an optimal configuration for the entire system. For example, it may calculate a EGS based on the received OCRSs. In parallel, BAD checks based on the received OCRS sets and the network state if any of the CFs might be rogue. If none of the CFs is rogue (S7=no), the value of the network configuration parameter calculated by OCC is the final value and the workflow ends (S8). The final value of the network configuration parameter may be set in the network.

If at least one of the CFs appears to be rogue according to the check by BAD in S6 (S7 =yes), BAD requests CPT to confirm the assessment by BAD and provides the relevant data (OCRSs, names of the CFs, value of the network configuration parameter c) to CPT. CPT may have obtained the network state directly from the network, and/or BAD may additionally provide the network state to CPT.

In S10, CPT checks for each of the CFs indicated by BAD if the respective triple <s, p, t> is trackable to the respective CF. If it is not trackable (S10=no), the workflow continues to S11. Accordingly, the value of the network configuration parameter calculated by OCC is the final value and the workflow ends. The final value of the network configuration parameter may be set in the network.

If the triple is trackable for at least one of the CFs indicated by BAD is trackable (S10=yes), the workflow continues to S12. In this case, CPT requests CPC to add an error (noise) to the value of the network configuration parameter calculated by OCC to obtain a final value which may be set in the network. The workflow ends.

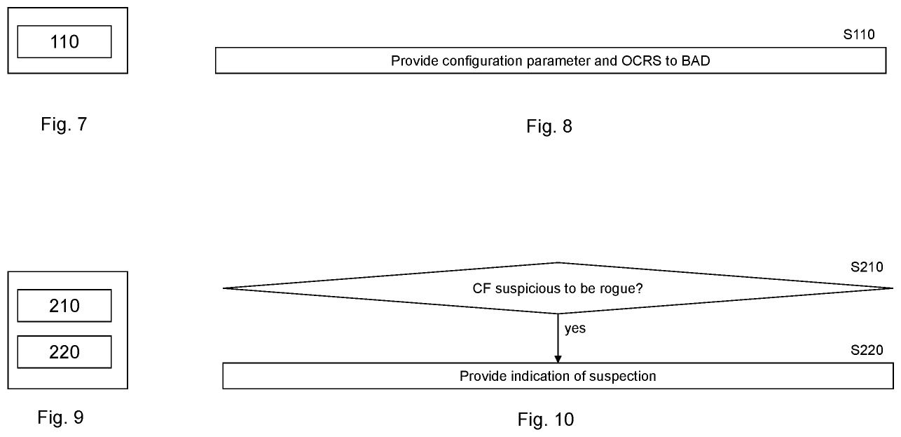

FIG. 7 shows an apparatus according to an example embodiment of the invention. The apparatus may be a controller, or an element thereof. FIG. 8 shows a method according to an example embodiment of the invention. The apparatus according to FIG. 8 may perform the method of FIG. 7 but is not limited to this method. The method of FIG. 7 may be performed by the apparatus of FIG. 8 but is not limited to being performed by this apparatus.

The apparatus comprises means for providing 110. The means for providing 110 may be a providing means. The means for providing 110 may be a provider. The means for providing 110 may be a providing processor.

The means for providing 110 provides a configuration parameter, such as a system configuration parameter (in particular a network configuration parameter), and, for at least one of plural cognitive functions, a OCRS for the configuration parameter received from the respective cognitive function to a BAD (S110).

FIG. 9 shows an apparatus according to an example embodiment of the invention. The apparatus may be a behavior anomaly detector, such as a BAD, or an element thereof. FIG. 10 shows a method according to an example embodiment of the invention. The apparatus according to FIG. 9 may perform the method of FIG. 10 but is not limited to this method. The method of FIG. 10 may be performed by the apparatus of FIG. 9 but is not limited to being performed by this apparatus.

The apparatus comprises means for checking 210 and means for providing 220. The means for checking 210 and means for providing 220 may be a checking means and providing means, respectively. The means for checking 210 and means for providing 220 may be a checker and provider, respectively. The means for checking 210 and means for providing 220 may be a checking processor and providing processor, respectively.

The means for checking 210 checks if at least one of one or more cognitive functions is suspicious to be rogue, i.e. if the at least one cognitive function(s) is/are suspected for manipulative behaviour (S210). For example, the checking may comprise comparing a request from the cognitive function with previous requests from the cognitive function.

If the cognitive function is suspected for manipulative behaviour (S210=yes), the means for providing 220 provides an indication (S220). The indication indicates that the cognitive function is suspected for manipulative behaviour. The indication may be provided to at least one of a CPT, an operator of a system (e.g. network) which the cognitive function controls, a controller of the system (e.g. network), and the cognitive function.

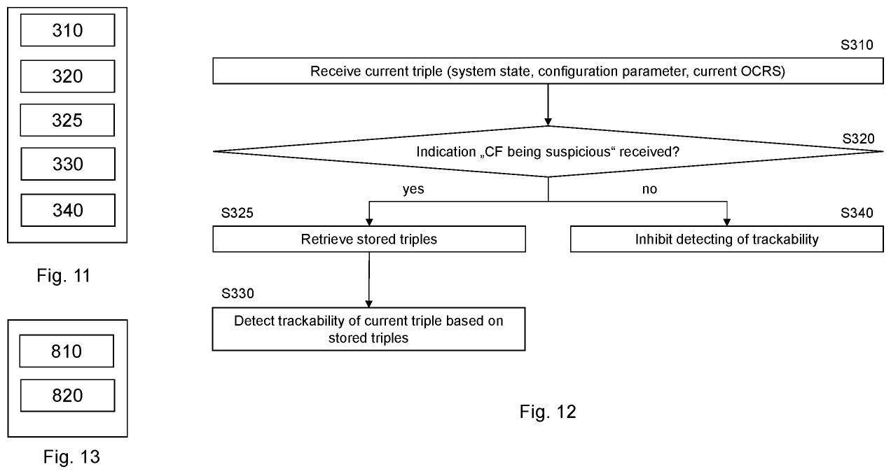

FIG. 11 shows an apparatus according to an example embodiment of the invention. The apparatus may be a CPT, or an element thereof. FIG. 12 shows a method according to an example embodiment of the invention. The apparatus according to FIG. 11 may perform the method of FIG. 12 but is not limited to this method. The method of FIG. 12 may be performed by the apparatus of FIG. 11 but is not limited to being performed by this apparatus.

The apparatus comprises means for receiving 310, means for checking 320, means for retrieving 325, means for detecting 330, and means for inhibiting 340. The means for receiving 310, means for checking 320, means for retrieving 325, means for detecting 330, and means for inhibiting 340 may be a receiving means, checking means, retrieving means, detecting means, and inhibiting means, respectively. The means for receiving 310, means for checking 320, means for retrieving 325, means for detecting 330, and means for inhibiting 340 may be a receiver, checker, retriever, detector, and inhibitor, respectively. The means for receiving 310, means for checking 320, means for retrieving 325, means for detecting 330, and means for inhibiting 340 may be a receiving processor, checking processor, retrieving processor, detecting processor, and inhibiting processor, respectively.

The means for receiving 310 receives an information on a current system state (e.g. a network state), a configuration parameter, a calculated value of the configuration parameter and, for each of one or more cognitive functions, a current optimal configuration range set for the configuration parameter with respect to the respective cognitive function (S310). The current system state (e.g. current network state) indicates a current state of a system (e.g. network). The optimal configuration range set indicates a range of values for the configuration parameter. The configuration parameter defines at least a part of a configuration of the system (e.g. network).

The means for checking 320 checks, for each of the one or more cognitive functions, if an indication is received (S320). The indication indicates that the respective cognitive function is suspicious to be rogue, i.e. that the cognitive is suspected for manipulative behavior.

The means for retrieving 325 retrieves for each of the one or more cognitive functions, respective one or more stored triples (S325). Each of the one or more stored triples comprises an information on a respective previous system state (e.g. previous network state), a respective applied value of the configuration parameter, and a respective previous optimal configuration range set for the configuration parameter with respect to the respective cognitive function.

S310, S320, and S325 may be performed in an arbitrary sequence. They may be performed fully or partly in parallel. In some example embodiments, S325 is performed only if the indication is received (S320=yes).

If the indication is received (S320=yes), the means for detecting 330 detects, for each of the one or more cognitive functions, whether or not the respective current triple is trackable for the cognitive function (S330). The detecting (S330) is based on the retrieved stored one or more triples for the respective cognitive function of S325. For each of the one or more cognitive functions, the respective current triple comprises the current system state, the calculated value of the configuration parameter, and the current optimal configuration range set for the configuration parameter with respect to the respective cognitive function, i.e., the parameters received in S310.

On the other hand, if the indication is not received (S320=no), the means for inhibiting 340 inhibits the detecting of S330 (S340).

FIG. 13 shows an apparatus according to an embodiment of the invention. The apparatus comprises at least one processor 810, at least one memory 820 including computer program code, and the at least one processor 810, with the at least one memory 820 and the computer program code, being arranged to cause the apparatus to at least perform at least one of the methods according to FIGS. 8, 10, and 12 and related description.

Some example embodiments of this invention are particularly useful for the operation of Network Automation Functions (NAF) in mobile networks. Some example embodiments are explained with respect to a 5G network (NR). However, the invention is not limited to 5G. It may be used in other networks, too, e.g. in former or forthcoming generations of 3GPP networks such as 4G, 6G, 7G, etc. It may be used in any wireless (mobile) and wireline communication networks. It may be used even outside of communication networks where CFs act as agent of a controller to autonomously influence the configuration of a system. An example of the latter is factory automation. In this case, the term “network” covers the machines controlled by the CAN. A network may be seen as a particular kind of a system. The invention is generally applicable to any kind of systems.

The controller may have a configuration as shown in FIG. 3. However, in some example embodiments of the invention, the controller may comprise additional functions are less functions. For example, in some example embodiments, the controller does not comprise DM, or a DM which calculates only one of the t-value and the m-value.

Some example embodiments of the invention are described where the rogue CF provides a wrong OCRS to the controller. However, in some example embodiments, the rogue CF may provide a wrong UF or a wrong UF and a wrong OCRS to the controller. However, typically, a wrong UF does not degrade the overall system performance as much as a wrong OCRS.

One piece of information may be transmitted in one or plural messages from one entity to another entity. Each of these messages may comprise further (different) pieces of information.

Names of network elements, network functions, protocols, and methods are based on current standards. In other versions or other technologies, the names of these network elements and/or network functions and/or protocols and/or methods may be different, as long as they provide a corresponding functionality.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware. It does not necessarily mean that they are based on different software. That is, each of the entities described in the present description may be based on different software, or some or all of the entities may be based on the same software. Each of the entities described in the present description may be deployed in the cloud.

According to the above description, it should thus be apparent that example embodiments of the present invention provide, for example, a behavioural anomaly detector, such as a BAD, or a component thereof, an apparatus embodying the same, a method for controlling and/or operating the same, and computer program(s) controlling and/or operating the same as well as mediums carrying such computer program(s) and forming computer program product(s). According to the above description, it should thus be apparent that example embodiments of the present invention provide, for example, a configuration parameter tracking function such as a CPT, or a component thereof, an apparatus embodying the same, a method for controlling and/or operating the same, and computer program(s) controlling and/or operating the same as well as mediums carrying such computer program(s) and forming computer program product(s). According to the above description, it should thus be apparent that example embodiments of the present invention provide, for example, a configuration parameter camouflaging function such as a CPC, or a component thereof, an apparatus embodying the same, a method for controlling and/or operating the same, and computer program(s) controlling and/or operating the same as well as mediums carrying such computer program(s) and forming computer program product(s).

Implementations of any of the above described blocks, apparatuses, systems, techniques or methods include, as non-limiting examples, implementations as hardware, software, firmware, special purpose circuits or logic, general purpose hardware or controller or other computing devices, or some combination thereof. Each of the entities described in the present description may be embodied in the cloud.

It is to be understood that what is described above is what is presently considered the preferred embodiments of the present invention. However, it should be noted that the description of the preferred embodiments is given by way of example only and that various modifications may be made without departing from the scope of the invention as defined by the appended claims.

1-30. (canceled)

31. Apparatus comprising:
one or more processors, and
memory storing instructions that, when executed by the one or more processors, cause the apparatus to perform:
providing a configuration parameter and, for at least one of plural cognitive functions, a optimal configuration range set for the configuration parameter received from the respective cognitive function to a behavioral anomaly detection function.

32. The apparatus according to claim 31, wherein the instructions, when executed by the one or more processors, further cause the apparatus to perform:
calculating an optimized value for the configuration parameter based on the received optimal configuration range sets.

33. The apparatus according to claim 32, wherein the instructions, when executed by the one or more processors, further cause the apparatus to perform:
monitoring if an indication is received that at least one of the cognitive functions is suspected for manipulative behavior;
adding a noise to the calculated optimized value to obtain a final value of the configuration parameter if the indication is received;
setting the final value of the configuration parameter equal to the calculated optimized value if the indication is not received;
applying the final value of the configuration parameter to the system.

34. The apparatus according to claim 33, wherein the instructions, when executed by the one or more processors, further cause the apparatus to perform:
providing the optimized value of the configuration parameter to a configuration parameter tracking function, wherein
the noise is received from a configuration parameter camouflaging function.

35. Apparatus comprising:
one or more processors, and
memory storing instructions that, when executed by the one or more processors, cause the apparatus to perform:
checking if at least one of one or more cognitive functions is suspected for manipulative behavior;
providing an indication that the at least one of the one or more cognitive function is suspected for manipulative behavior if the at least one cognitive function is suspected for manipulative behavior.

36. The apparatus according to claim 35, wherein
the indication is provided to at least one of a configuration parameter tracking function, an operator of a system which the cognitive function controls, a controller of the system, and the cognitive function.

37. The apparatus according to claim 35, wherein the instructions, when executed by the one or more processors, further cause the apparatus to perform:
receiving a current system state, a configuration parameter and, for each of the one or more cognitive functions, a current optimal configuration range set for the configuration parameter with respect to the respective cognitive function;
retrieving, for each of the one or more cognitive functions, one or more pairs stored for the respective cognitive function; wherein
the checking comprises, for each of the one or more cognitive functions, comparing a respective current pair with the retrieved one or more pairs stored for the respective cognitive function and determining if the respective current pair is unexpected in view of the retrieved one or more pairs stored for the respective cognitive function by more than a predefined error margin: wherein,
for each of the one or more cognitive functions, the respective current pair comprises the current system state and the current optimal configuration range set for the configuration parameter with respect to the respective cognitive function;
for each of the one or more cognitive functions, each of the one or more stored pairs comprises an information on a respective previous system state and a respective previous optimal configuration range set for the configuration parameter with respect to the respective cognitive function;
each of the optimal configuration range sets indicates a respective range of values for the configuration parameter;
the configuration parameter defines at least a part of a configuration of the system.

38. The apparatus according to claim 37, wherein the instructions, when executed by the one or more processors, further cause the apparatus to perform:
storing, for each of the cognitive functions, the respective current pair along with the respective one or more stored pairs.

39. Method comprising:
providing a configuration parameter and, for at least one of plural cognitive functions, a optimal configuration range set for the configuration parameter received from the respective cognitive function to a behavioral anomaly detection function.

40. The method according to claim 39, further comprising:
calculating an optimized value for the configuration parameter based on the received optimal configuration range sets.

41. The method according to claim 39, further comprising:
monitoring if an indication is received that at least one of the cognitive functions is suspected for manipulative behavior;
adding a noise to the calculated optimized value to obtain a final value of the configuration parameter if the indication is received;
setting the final value of the configuration parameter equal to the calculated optimized value if the indication is not received;
applying the final value of the configuration parameter to the system.

42. The method according to claim 41, further comprising:
providing the optimized value of the configuration parameter to a configuration parameter tracking function, wherein
the noise is received from a configuration parameter camouflaging function.

43. Method comprising:
checking if at least one of one or more cognitive functions is suspected for manipulative behavior;
providing an indication that the at least one of the one or more cognitive function is suspected for manipulative behavior if the at least one cognitive function is suspected for manipulative behavior.

44. The method according to claim 43, wherein
the indication is provided to at least one of a configuration parameter tracking function, an operator of a system which the cognitive function controls, a controller of the system, and the cognitive function.

45. The method according to claim 43, further comprising:
receiving a current system state, a configuration parameter and, for each of the one or more cognitive functions, a current optimal configuration range set for the configuration parameter with respect to the respective cognitive function;
retrieving, for each of the one or more cognitive functions, one or more pairs stored for the respective cognitive function; wherein
the checking comprises, for each of the one or more cognitive functions, comparing a respective current pair with the retrieved one or more pairs stored for the respective cognitive function and determining if the respective current pair is unexpected in view of the retrieved one or more pairs stored for the respective cognitive function by more than a predefined error margin; wherein,
for each of the one or more cognitive functions, the respective current pair comprises the current system state and the current optimal configuration range set for the configuration parameter with respect to the respective cognitive function;
for each of the one or more cognitive functions, each of the one or more stored pairs comprises an information on a respective previous system state and a respective previous optimal configuration range set for the configuration parameter with respect to the respective cognitive function;
each of the optimal configuration range sets indicates a respective range of values for the configuration parameter;
the configuration parameter defines at least a part of a configuration of the system.

46. The method according to claim 45, further comprising:
storing, for each of the cognitive functions, the respective current pair along with the respective one or more stored pairs.
